(19) United States
(12) Patent Application Publication
(10) Pub. No.: US 2024/0204955 A1
(43) Pub. Date: Jun. 20, 2024

(54) LATENCY REDUCTION DURING WIRELESS MOBILITY

(71) Applicant: ZTE Corporation, Shenzhen (CN)

(72) Inventors: Ling YANG, Shenzhen (CN); Bo GAO, Shenzhen (CN); Zhaohua LU, Shenzhen (CN); Ke YAO, Shenzhen (CN); Shujuan ZHANG, Shenzhen (CN); Yang ZHANG, Shenzhen (CN); Xiaolong GUO, Shenzhen (CN)

(21) Appl. No.: 18/397,671

(22) Filed: Dec. 27, 2023

Related U.S. Application Data
(63) Continuation of application No. PCT/CN2022/122954, filed on Sep. 29, 2022.

(51) Int. Cl. H04L 5/00; H04L 1/1812; H04L 1/1829

(52) U.S. Cl. CPC H04L 5/0053; H04L 1/1812; H04L 1/1858

(57) ABSTRACT

Methods, systems, apparatus for wireless communication are described. One example method of wireless communication includes receiving, by a wireless device, one or more signaling that indicate one or more of a reference signal (RS), a transmission configuration information (TCI state), or a cell information; and configuring the wireless device to operate according to the one or more signaling.

### CROSS REFERENCE TO RELATED APPLICATIONS

This patent document is a continuation of and claims benefit of priority to International Patent Application No. PCT/CN2022/122954, filed on Sep. 29, 2022. The entire content of the before-mentioned patent application is incorporated by reference as part of the disclosure of this application.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for to allow layer 1/layer 2 (L1/L2) mobility of wireless devices such as user equipment (UE).

In one example aspect, a method of wireless communication is disclosed. The method includes receiving, by a wireless device, one or more signaling that indicate one or more of a reference signal (RS), a transmission configuration information (TCI state), or a cell information; and configuring the wireless device to operate according to the one or more signaling.

In another example aspect, another method of wireless communication is disclosed. The method includes transmitting, by a network device to a wireless device, one or more signaling that indicate one or more of a reference signal (RS), a transmission configuration information (TCI state), or a cell information.

In yet another exemplary aspect, the above-described methods are embodied in the form of a computer-readable medium that stores program code. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example of offset to a start time of a transmission.

FIG. 2 shows an example of use of a gap and an offset for transmissions.

FIG. 3 shows example transmission positions (in time) for reference signals and reports.

FIG. 4A-4B show an exemplary flowchart for wireless communication.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

### DETAILED DESCRIPTION

This patent document describes application time related techniques for information in L1/L2 mobility enhancements. The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### Initial discussion

When the UE moves from the coverage area of one cell to another cell, at some point a serving cell change needs to be performed. Currently serving cell change is triggered by L3 measurements and is done by RRC signaling triggered Reconfiguration with Synchronization for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signaling, in order to reduce the latency, overhead and interruption time.

The present document discloses, among other things, a method that allows embodiments to achieve latency reduction for L1/L2 mobility.

In RAN Plenary #94 e-meeting, a new work item (WI) on Further NR mobility enhancements was approved. The goal of this work is to enable a serving cell change via L1/L2 signaling with low latency, overhead and interruption time. Wherein, DL synchronization part after switch command is one of main aspects that contributes to large interruption or latency time. Based on this, some enhancements need to be considered, such as synchronization signal physical broadcast channel (SS/PBCH) block used to achieve at least one of cell search, AGC (Automatic Gain Control) setting, time/frequency tracking and fine timing tracking can be replaced with aperiodic tracking reference signal (AP-TRS) or aperiodic channel state information reference signal (AP-CSI-RS). Further, related signaling design and quasi-colocation (QCL) assumption also need to be further studied.

The present document discloses some feasible solutions to the issue mentioned above, and other solutions.

In some embodiments, CSI request field used for triggering AP-TRS is only introduced in DCI format 0_1 and DCI format 0_2. Transmission configuration indication field used for indicating TCI state is introduced in DCI format 1_1 and DCI format 1_2.

Some disclosed embodiments for reducing DL sync latency can be applied after/before switch command.

In some embodiments, a signaling to indicate or trigger TCI state and/or TRS/CSI-RS can be at least one of DCI signaling, MAC CE signaling, a signaling or command to trigger mobility or cell switch.

In some embodiments, DCI signaling or MAC CE signaling mentioned below can be regard as a cell switch command, or candidate cell switch command, or a command of triggering mobility.

In some embodiments, TRS or CSI-RS can be periodic, or semi-persistent, or aperiodic. Optionally, a signaling to trigger semi-persistent TRS or CSI-RS can be reused the existing signaling, or a signaling to triggering cell switch, or an existing signaling with some enhancement.

In some embodiments, a cell information may include or may be comprised of cell identification.

### Embodiment 1 (DCI Indicates TCI State and AP-TRS/CSI-RS)

Embodiment 1 describes example methods to indicate TCI state (or target candidate cell) and TRS and/or CSI-RS by using combined downlink control information (DCI). To be specific,

Alternative-1.1: One combined DCI signaling to indicate or update or activate at least one of one or more TCI state and one or more TRS and/or CSI-RS;

In order to support alternative-1.1, at least one of the following enhancements can be introduced:

Option-1.1-1: Introduce a new field on Transmission configuration indication in DCI format 0_1;

In some embodiment, a new field on Transmission configuration indication is used to indicate a beam for UE. UE can use the indicated TCI state or beam to reception or transmission signal/channel or data. The size of this new field or the number of bit of this new field can be determined by at least one of pre-defined, RRC signaling, MAC CE signaling.

Note that CSI request field used for triggering AP-TRS and/or AP-CSI-RS has been included in DCI format 0_1. In some embodiments, the codepoint of CSI request field is associated with trigger state. Wherein, if CSI request field is set to 0, it means that No CSI requested. If CSI request is set to a value rather than 0, it means that this field indicates a trigger state. Herein, a trigger state includes CSI-reportConfigID and resource set. Optionally, aperiodic CSI-RS resource is determined based on an RRC parameter (e.g., aperiodicTriggeringOffset) that is a gap between DCI that triggers aperiodic CSI-RS and aperiodic CSI-RS resource.

Option-1.1-2: Introduce a new field on Transmission configuration indication in DCI format 0_2;

Note that: CSI request field used for triggering AP-TRS and/or AP-CSI-RS has been included in DCI format 0_2.

Option-1.1-3: Introduces a new field on CSI request to trigger AP-TRS and/or AP-CSI-RS in DCI format 1_1;

Note that: Transmission configuration indication field has been included in DCI format 1_1.

Option-1.1-4: Introduces a new field on CSI request to trigger AP-TRS and/or AP-CSI-RS in DCI format 1_2;

Note that: Transmission configuration indication field has been included in DCI format 1_2.

Option-1.1-5: A new DCI format or other existing DCI format introduces one field on CSI request to trigger AP-TRS and/or AP-CSI-RS and/or another field on Transmission configuration indication.

In some embodiment, CSI request field in above mentioned DCI format can be used for at least one of indicating No triggering AP-TRS and/or AP-CSI-RS, triggering AP-TRS and/or AP-CSI-RS, triggering AP-TRS and/or AP-CSI-RS and indicating the number of AP-TRS and/or AP-CSI-RS transmission or resource or resource set or burst, or indication the pattern of AP-TRS and/or AP-CSI-RS transmission or resource or resource set or burst, or, indicating AP-TRS and/or AP-CSI-RS is transmitted in which TRS and/or CSI-RS transmission or resource or resource set or burst.

Option-1.1-6: CSI request field in DCI format 0_1/0_2 can be re-interpreted.

In some embodiment, CSI request field in DCI format 0_1/0_2 can be used for at least one of:
No triggering AP-TRS and/or AP-CSI-RS;
No indicating TCI state;
Triggering AP-TRS and/or AP-CSI-RS;
Indicating TCI state;
No triggering AP-TRS and/or AP-CSI-RS and indicating TCI state;
Triggering AP-TRS and/or AP-CSI-RS and No indicating TCI state;
Triggering AP-TRS and/or AP-CSI-RS and indicating TCI state;
Triggering AP-TRS and/or AP-CSI-RS, and indicating a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst;
Triggering AP-TRS and/or AP-CSI-RS, and indicating a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst and no indicating TCI state;
Triggering AP-TRS and/or AP-CSI-RS, and indicating a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst and indicating TCI state;

Optionally, a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst can be replaced with one of the number of AP-TRS and/or AP-CSI-RS transmission or resource or resource set or burst, or indicating AP-TRS and/or AP-CSI-RS is transmitted in which TRS and/or CSI-RS transmission or resource or resource set or burst.

In some embodiment, different codepoint of CSI request field corresponds to or associated with different TCI state information if TCI state can be indicated by CSI request field.

Option-1.1-7: Transmission configuration indication field in DCI format 1_1/1_2 can be re-interpreted.

In some embodiment, Transmission configuration indication field in DCI format 1_1/1_2 can be used for indicating TCI state, and triggering AP-TRS and/or AP-CSI-RS or no triggering AP-TRS and/or AP-CSI-RS;

In some embodiment, Transmission configuration indication field in DCI format 1_1/1_2 can be used for indicating TCI state, and whether to trigger AP-TRS and/or AP-CSI-RS, and indicating the pattern of AP-TRS and/or AP-CSI-RS transmission or resource or resource set or burst.

Optionally, a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst can be replaced with one of the number of AP-TRS and/or AP-CSI-RS transmission or resource or resource set or burst, or indicating AP-TRS and/or AP-CSI-RS is transmitted in which TRS and/or CSI-RS transmission or resource or resource set or burst.

Each codepoint of Transmission configuration indication field corresponds to or associated with at least one of the following status:
No triggering AP-TRS and/or AP-CSI-RS;
No indicating TCI state;
Triggering AP-TRS and/or AP-CSI-RS;
Indicating TCI state;
No triggering AP-TRS and/or AP-CSI-RS and indicating TCI state;
Triggering AP-TRS and/or AP-CSI-RS and No indicating TCI state;
Triggering AP-TRS and/or AP-CSI-RS and indicating TCI state;
Triggering AP-TRS and/or AP-CSI-RS, and indicating a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst;
Triggering AP-TRS and/or AP-CSI-RS, and indicating a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst and no indicating TCI state;
Triggering AP-TRS and/or AP-CSI-RS, and indicating a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst and indicating TCI state;

In some embodiment, if TCI state used for candidate cell is indicated, then associated AP-TRS and/or AP-CSI-RS transmission or AP-TRS and/or AP-CSI-RS resource or AP-TRS and/or AP-CSI-RS resource set or AP-TRS and/or AP-CSI-RS burst can be triggered simultaneously.

Option-1.1-8: A new DCI format or other existing DCI format introduces one field for triggering AP-TRS and/or CSI-RS and/or indicating or updating Transmission configuration indication.

In some embodiment, this field can be used for at least one of indicating TCI state, triggering AP-TRS and/or AP-CSI-RS, indicating the pattern of AP-TRS and/or AP-CSI-RS transmission or resource or resource set or burst.

Optionally, a pattern of AP-TRS and/or AP-CSI-RS transmission or AP-TRS and/or AP-CSI-RS resource or AP-TRS and/or AP-CSI-RS resource set or AP-TRS and/or AP-CSI-RS burst can be replaced with one of the number of AP-TRS and/or AP-CSI-RS transmission or resource or resource set or burst, or indicating AP-TRS and/or AP-CSI-RS is transmitted in which TRS and/or CSI-RS transmission or resource or resource set or burst.

Optionally, the meaning of each codepoint of this field can refer to any of the above mentioned in this embodiment or disclosure.

Note that: TCI state indicated or updated by Transmission configuration indication field can be used for serving cell and/or candidate cell, or, is associated with at least one of serving cell and candidate cell.

Note that: AP-TRS and/or AP-CSI-RS can be associated with a TCI state or candidate cell.

Optionally, AP-TRS and/or AP-CSI-RS, and/or TCI state and/or candidate cell can be associated with each other.

Note that: within AP-TRS and/or AP-CSI-RS burst, TRS and/or CSI-RS resource can reuse the existing time transmission occasion, or define the new time and/or frequency domain transmission occasion.

### Embodiment 2 (MAC CE Indicates TCI State and AP-TRS/CSI-RS)

Embodiment 2 describes example methods to indicate TCI state and/or TRS and/or CSI-RS by using combined medium access control element (MAC CE). To be specific,

Alternative-2.1: at least one of one or more TCI state and trigger one or more TRS and/or CSI-RS can be indicated or triggered by one combined MAC CE signaling;

In some embodiment, one or more AP-TRS and/or AP-CSI-RS transmission or resource or resource set or burst correspond to, or associated with TCI State for serving cell and/or candidate cell, or associated with candidate cell. In some embodiment, TCI state associated with candidate cell or correspond to, or associated with candidate cell.

In order to support alternative-2.1, at least one of the following options can be considered:

Option-2.1-1: using the existing MAC CE signaling to indicate or update or activate or trigger at least one of one or more TCI state and one or more TRS and/or CSI-RS;

If the existing MAC CE signaling supports TCI state indication or update or activation/deactivation, then a new field for triggering TRS and/or CSI-RS or indication TRS and/or CSI-RS transmission position can be introduced. Optionally, triggering or indicating one or more AP-TRS and/or AP-CSI-RS transmission or resource or resource set or burst.

If the existing MAC CE signaling supports triggering one or more AP-TRS and/or AP-CSI-RS transmission or resource or resource set or burst, or, periodic TRS and/or periodic CSI-RS, or, semi-persistent TRS and/or semi-persistent CSI-RS, then a new field for TCI state indication can be introduced.

If aperiodic TRS and/or CSI-RS is supported, then periodic TRS and/or periodic CSI-RS, or, semi-persistent TRS and/or semi-persistent CSI-RS in existing MAC CE signaling can be replaced with aperiodic TRS and/or CSI-RS.

If the existing MAC CE signaling supports TCI state indication or update or activation/deactivation, and, supports periodic TRS and/or CSI-RS or aperiodic TRS and/or CSI-RS or semi-persistent TRS and/or CSI-RS,

If the existing MAC CE signaling does not support neither TCI state indication or update or activation/deactivation, nor, periodic TRS and/or CSI-RS or aperiodic TRS and/or CSI-RS or semi-persistent TRS and/or CSI-RS, then at least one of the following can be considered:

A new field for triggering or indicating TRS and/or CSI-RS can be introduced; Wherein, the detailed design can refer to the method or rule above mentioned.

A new field for TCI state indication can be introduced. Wherein, the detailed design can refer to the method or rule above mentioned.

A new field for indicating TCI state and triggering or indicating TRS and/or CSI-RS can be introduced. Wherein, the detailed design can be referred to the method or rule above mentioned.

Option-2.1-2: using a new MAC CE signaling to indicate or update or activate or trigger at least one of one or more TCI state and one or more TRS and/or CSI-RS;

A new field for triggering or indicating TRS and/or CSI-RS can be introduced; Wherein, the detailed design can refer to the method or rule above mentioned.

A new field for TCI state indication can be introduced. Wherein, the detailed design can refer to the method or rule above mentioned.

A new field for indicating TCI state and triggering or indicating TRS and/or CSI-RS can be introduced. Wherein, the detailed design can refer to the method or rule above mentioned.

### Embodiment 3 (DCI Indicates Cell ID and AP-TRS/CSI-RS)

Different from embodiment 1, embodiment 3 describes example methods on whether to introduce Cell information in DCI signaling explicitly or implicitly.

Note that: Cell can be at least one of serving cell and candidate cell.

Note that: Cell information can be cell ID, or cell index, or other information related cell.

In some embodiment, a new field on cell information can be introduced in DCI signaling. This field is used to indicate or update or activate/deactivate one or more Cells or Cell identifications.

In some embodiment, if this field presents, it means that the indicated TCI state and/or TRS/CSI-RS is associated to or indicated or applied for the current indicated cell. If this field absent, then it means that the indicated TCI state and/or TRS/CSI-RS is associated to or indicated or applied for serving cell or serving TRP.

In some embodiment, if a new field on cell information is not introduced in DCI signaling, then cell information can be obtained by implicitly method. In some example, cell information can be obtained or determined by association between TCI state and cell, or association between TRS and/or CSI-RS and cell, or association between TRS and/or CSI-RS and TCI state. Optionally, association between TCI state and cell, or association between TRS and/or CSI-RS and cell, or association between TRS and/or CSI-RS and TCI state is determined by at least one of pre-defined, or MAC CE, RRC, DCI.

In this embodiment or disclosure, TRS and/or CSI-RS can be periodic, or aperiodic, or semi-persistent.

In some embodiments, one combined DCI signaling can indicate or update or activate or trigger at least one or more target candidate cells and one or more TRS and/or CSI-RS and TCI state by one field or individual field. Optionally, TCI state in embodiment 1 can be replaced with cell or cell information. Optionally, a field on cell information can be introduced in a DCI signaling above mentioned.

In some embodiment, any association of Cell ID/information, TCI state, RS in TCI state, TRS and/or CSI-RS also belongs to the scope of this disclosure.

### Embodiment 4 (MAC CE Indicates Cell ID and AP-TRS/CSI-RS)

Different from embodiment 2, embodiment 4 embodiment 3 describes example methods on whether to introduce Cell information in MAC CE signaling explicitly or implicitly.

Note that: Cell can be at least one of serving cell and candidate cell.

Note that: Cell information can be cell ID, or cell index, or other information related cell.

In some embodiment, MAC CE signaling introduces a new field on Cell information. This field is to indicate or update or activate/deactivate one or more Cells or Cell identifications.

In some embodiment, if this field presents, it means that the indicated TCI state and/or TRS/CSI-RS is associated to or indicated or applied for the current indicated cell. If this field absent, then it means that the indicated TCI state and/or TRS/CSI-RS is associated to or indicated or applied for serving cell or serving TRP.

In some embodiment, if a new field on cell information is not introduced in DCI signaling, then cell information can be obtained by implicitly method. In some example, cell information can be obtained or determined by association between TCI state and cell, or association between TRS and/or CSI-RS and cell, or association between TRS and/or CSI-RS and TCI state. Optionally, association between TCI state and cell, or association between TRS and/or CSI-RS and cell, or association between TRS and/or CSI-RS and TCI state is determined by at least one of pre-defined, or MAC CE, RRC, DCI.

In this embodiment or disclosure, TRS and/or CSI-RS can be periodic, or aperiodic, or semi-persistent.

In this embodiment or disclosure, one combined MAC CE signaling can indicate or update or activate or trigger at least one or more target candidate cells and one or more TRS and/or CSI-RS and TCI state by one field or individual field. Optionally, TCI state in embodiment 2 can be replaced with cell or cell information. Optionally, a field on cell information can be introduced in a MAC CE signaling above mentioned.

In some embodiment, any association of Cell ID/information, TCI state, RS in TCI state, TRS and/or CSI-RS also belongs to the scope of this disclosure.

### Embodiment 5 (Different Signaling Indicate TCI State and AP-TRS/CSI-RS, Respectively)

Embodiment 5 describes example methods to indicate or update or activate at least one of one or more TCI states and one or more TRS and/or CSI-RS by using separate signaling message. Here, signaling message can be downlink control information (DCI), or, medium access control element (MAC CE).

In some embodiment, one or more TCI state is associated with a candidate cell or target cell or PCI that is different from the serving cell, or, TRS and/or CSI-RS.

To be specific, at least one of the following alternatives can be used to indicate or update or activate at least one of one or more TCI states and one or more TRS and/or CSI-RS:

| Alternatives | TCI state | TRS and/or CSI-RS |
|---|---|---|
| Alt-5.1 | MAC CE#1 | MAC CE#2 |
| Alt-5.2 | MAC CE | DCI |
| Alt-5.3 | DCI #1 | DCI #2 |
| Alt-5.4 | DCI | MAC CE |

Alternative-5.1: one MAC CE to indicate or update or activate one or more TCI state and another MAC-CE to indicate or update or activate or trigger one or more TRS and/or CSI-RS;

Alternative-5.2: one MAC CE to indicate or update or activate one or more TCI state and one DCI to indicate or update or activate or trigger one or more TRS and/or CSI-RS;

Alternative-5.3: one DCI to indicate or update or activate one or more TCI state and another DCI to indicate or update or activate or trigger one or more TRS and/or CSI-RS;

Alternative-5.4: one DCI to indicate or update or activate one or more TCI state and one MAC CE to indicate or update or activate or trigger one or more TRS and/or CSI-RS;

(1) For the case that MAC CE indicates or updates or activates one or more TCI states,
Optionally, the maximum number of indicated or activated or updated TCI state depends on UE capability, or is determined by pre-defined, DCI signaling, MAC CE signaling, RRC signaling, the number of cell, or the number of TRS/CSI-RS.
Optionally, one TCI state can be associated with one cell identification, or more TCI states can be associated with a cell or different cells including serving cell and candidate cell or target cell.
One or more TCI states can be applied starting from a specific time. Wherein, specific time can be the first slot or symbol or subframe or frame that is after
   a) n+X*Y, or b) a time duration, where
      For a), n is a position in which UE starts or ends receiving PDSCH (physical downlink shared channel) carrying MAC CE signaling, or UE starts or ends sending hybrid automatic request acknowledgement HARQ-ACK information corresponding to the PDSCH carrying MAC CE signaling; X is an integer larger than 1, such as, 1, 2, 3, 4, 5, 6, 7, 8, 9, 10, etc .; Y is the number of at least one of slot, subframe, symbol, frame;
      For b), a time duration consists of at least one of starting position, ending position, time length. Start of time duration can be a time that UE starts or ends receiving PDSCH carrying MAC CE signaling, or UE starts or ends sending HARQ-ACK information corresponding to the PDSCH carrying MAC CE signaling. Ending of time duration or the length of time duration can be configured or fixed value.
         (2) For the case that DCI indicates or updates or activates one or more TCI states,
Optionally, the maximum number of indicated or activated or updated TCI state depends on UE capability, or is determined by pre-defined, DCI signaling, MAC CE signaling, RRC signaling, the number of cell, or the number of TRS/CSI-RS.
Optionally, one TCI state can be associated with one cell identification, or more TCI states can be associated with a cell or different cells including serving cell and candidate cell or target cell.
In some embodiment, one or more TCI state can be indicated by a codepoint from TCI field of DCI signaling. For example, if one codepoint corresponds to two TCI state, one TCI state is associated to serving cell, another TCI state is associated to candidate cell or target cell. Or, one TCI state is associated to candidate cell with Cell ID #1, another TCI state is associated to candidate cell with Cell ID #2. Note that “associated to” mentioned above can be also replaced with “indicated by”.
One or more TCI states indicated or updated by DCI can be applied starting from a specific time. Wherein,
   specific time can be the first slot or symbol or subframe or frame that at least gap in symbol or slot or subframe or frame after reference position.
      Reference position can be a position in which UE starts or ends receiving DCI signaling, or UE starts or ends sending HARQ-ACK information corresponding to DCI signaling that indicates TCI state or corresponding to the PDSCH scheduled by DCI signaling carrying TCI state.
      Gap can be configurable or fix or configured based on UE capability. Optionally, the signaling to configure gap can be pre-define, or RRC signaling, MAC CE signaling, or DCI signaling.
         (3) For the case that one or more TRS and/or CSI-RS are triggered or indicated or updated or activated by MAC CE,
MAC CE can trigger or indicate or update or activate one more TRS and/or CSI-RS resource or resource set or burst. Wherein,
   The position to transmit the first TRS or CSI-RS resource or resource set or burst can be determined based on an offset. Related content can be found in embodiment 8.
   The starting of the offset can be a time that UE starts or ends receiving or transmitting an information or signaling, or, UE starts or ends receiving PDSCH carrying MAC CE signaling, or, UE starts or ends sending HARQ-ACK information corresponding to the PDSCH carrying MAC CE signaling.
   The offset value can be configured by at least one of pre-defined method, RRC signaling, MAC CE signaling, DCI signaling. Optionally, the offset value can reuse the offset specified by aperiodicTriggeringOffset, or new parameter in signaling.
      (4) For the case that one or more TRS and/or CSI-RS are triggered or indicated or updated or activated by DCI signaling,
if TRS or CSI-RS is aperiodic, CSI request field in DCI signaling can be used for triggering AP-TRS, or AP CSI-RS.
   Optionally, CSI request field or a new field in DCI signaling can be used for triggering AP-TRS, and/or AP CSI-RS, and/or, indicate TRS or CSI-RS resource or resource set or transmission burst.
   Optionally, CSI request field or a new field in DCI signaling can be used for triggering AP-TRS, or AP CSI-RS, and/or, indicating corresponding Cell identification or additional PCI that is different from serving cell.
   Optionally, a triggering corresponds to the specific number of TRS or CSI-RS resource or resource set or transmission burst or time domain pattern of TRS or CSI-RS. Wherein, the specific value or time domain pattern can be configured by pre-defined or UE capability.
For periodic or semi-persistent TRS or CSI-RS, CSI request field or a new field in DCI signaling can be used for activating or enabling periodic or semi-persistent TRS or CSI-RS.
   Optionally, an activation indication or enabled indication corresponds to the specific number of TRS or CSI-RS resource or resource set or transmission burst or time domain pattern of TRS or CSI-RS. Wherein, the specific value or time domain pattern can be configured by pre-defined or UE capability.
The position to transmit the first TRS or CSI-RS can be determined based on an offset. Related content can be found in embodiment 8.
The starting of the offset can be a time in which UE starts or ends receiving or transmitting an information or signaling, or, UE starts or ends receiving DCI signaling, or UE starts or ends sending HARQ-ACK information corresponding to DCI signaling that indicates TRS or CSI-RS.
The offset value can be configured by at least one of pre-defined method, RRC signaling, MAC CE signaling, DCI signaling. Optionally, the offset value can reuse the offset specified by aperiodicTriggeringOffset, or new parameter in signaling.

### Embodiment 6 (Different Signaling Indicate Cell and TRS/CSI-RS, Respectively)

Embodiment 6 describes example methods to indicate Cell identification and/or TRS/CSI-RS by using separate signaling message. Wherein, signaling message can be downlink control information (DCI), or, medium access control element (MAC CE).

To be specific, at least one of the following alternatives can be used to indicate or update or activate one or more cell identifications and/or one or more TRS and/or CSI-RS:

| Alternatives | Cell identification | TRS and/or CSI-RS |
|---|---|---|
| Alt-6.1 | MAC CE#1 | MAC CE#2 |
| Alt-6.2 | MAC CE | DCI |
| Alt-6.3 | DCI #1 | DCI #2 |
| Alt-6.4 | DCI | MAC CE |

Alternative-6.1: one MAC CE to indicate or update or activate one or more cell identifications and another MAC-CE to indicate or update or activate or trigger one or more TRS and/or CSI-RS;

Alternative-6.2: one MAC CE to indicate or update or activate one or more cell identifications and one DCI to indicate or update or activate or trigger one or more TRS and/or CSI-RS;

Alternative-6.3: one DCI to indicate or update or activate one or more cell identifications and another DCI to indicate or update or activate or trigger one or more TRS and/or CSI-RS;

Alternative-6.4: one DCI to indicate or update or activate one or more cell identifications and one MAC CE to indicate or update or activate or trigger one or more TRS and/or CSI-RS;

(1) For the case that MAC CE indicates or updates or activates one or more cells or cell information,
Optionally, cell includes at least one of serving cell and candidate cell.
Optionally, if MAC CE only indicates or activates or updates one cell, then it is used for mobility.
Optionally, one or more TCI states are associated with a cell, or, each TCI state is associated with a cell, or, a cell is associated with one TCI state, or a cell is associated with more TCI states. Optionally, each cell can associate different number of TCI state. Specifically, the maximum number of indicated or activated or updated TCI state for serving cell or candidate cell or the maximum number of indicated or activated or updated cell depends on UE capability, or is determined by at least one of pre-defined, DCI signaling, MAC CE signaling, RRC signaling.
Optionally, if one or more cell identifications is indicated or updated or activated by MAC CE, then one or more TCI states associated with (or corresponding to) one or more cell identifications is simultaneously indicated or updated or activated.
Optionally, a field can be used to indicate whether each TCI state is for serving cell or candidate cell or is used to indicate serving cell or candidate cell. For example, Cell IDi represents the status of ith Cell ID. i=0 denotes serving cell ID, i≠0 denotes candidate cell ID.
Optionally, one or more cell and/or one or more TCI state associated with cell identification can be applied starting from a specific time.
   Optionally, cell identification and TCI state associated with (or corresponding to) cell identification can have same application time or different application time.
   Specific time can be the first slot or symbol or subframe or frame that is after a) n+X*Y, or b) a time duration, where
      For a), n is a position in which UE starts or ends receiving PDSCH carrying MAC CE signaling, or UE starts or ends sending HARQ-ACK information corresponding to the PDSCH carrying MAC CE signaling; X is an integer larger than 1, such as, 1, 2, 3, 4, 5, 6, 7, 8, 9, 10, etc.; Y is the number of at least one of slot, subframe, symbol, frame;
      For b), a time duration consists of at least one of starting position, ending position, time length. Start of time duration can be a time that UE starts or ends receiving PDSCH carrying MAC CE signaling, or UE starts or ends sending HARQ-ACK information corresponding to the PDSCH carrying MAC CE signaling. Ending of time duration or the length of time duration can be configured or fixed value.
         (2) For the case that DCI indicates or updates or activates one or more cell,
Optionally, cell can be at least one of serving cell and candidate cell.
Optionally, a cell identification field is introduced in DCI.
Optionally, the cell identification indicated in DCI is associated with TCI state indicated in the current DCI or different DCI signaling.
Optionally, the maximum number of indicated or activated or updated TCI state for serving cell or candidate cell, or, the maximum number of indicated or activated or updated cell, or, the maximum number of indicated or activated or updated TCI state depends on UE capability or is determined by pre-defined, DCI signaling, MAC CE signaling, RRC signaling, the number of cell, or the number of TRS/CSI-RS.
Optionally, each codepoint of the DCI Transmission configuration indication field has one corresponding cell identification, or each codepoint of the DCI Transmission configuration indication field is associated with a cell identification. Optionally, each codepoint includes one or more TCI states.
Optionally, if the number of TCI state for each codepoint is 2, then assume that first TCI state of each codepoint of the DCI Transmission configuration indication field is used for serving cell, or is associated with serving cell; the second TCI state of each codepoint of the DCI Transmission configuration indication field is used for candidate cell, or is associated with candidate cell. Optionally, if the number of TCI state for each codepoint is extended to C1, then the same logic mentioned above can be applied. C1 can be configurable or pre-defined or determined based on UE capability.
Optionally, one or more cell identifications and/or one or more TCI state associated with cell identification indicated or updated or activated by DCI can be applied starting from a specific time. Wherein,
   specific time can be the first slot or symbol or subframe or frame that at least gap in symbol or slot or subframe or frame after reference position.
      Reference position can be a position in which UE starts or ends receiving DCI signaling, or UE starts or ends sending HARQ-ACK information corresponding to DCI signaling that indicates TCI state or corresponding to the PDSCH scheduled by DCI signaling carrying TCI state.
      Gap can be configurable or fix or configured based on UE capability. Optionally, the signaling to configure gap can be pre-define, or RRC signaling, MAC CE signaling, or DCI signaling.
         (3) For the case that TRS and/or CSI-RS are triggered or indicated or updated or activated by MAC CE,
MAC CE can trigger or indicate or update or activate one more TRS and/or CSI-RS resource or resource set or burst. Wherein,
   The position to transmit the first TRS or CSI-RS can be determined based on an offset. Related content can be found in embodiment 8.
   The starting of the offset can be a time that UE starts or ends receiving or transmitting an information or signaling, or UE starts or ends receiving PDSCH carrying MAC CE signaling, or UE starts or ends sending HARQ-ACK information corresponding to the PDSCH carrying MAC CE signaling.
   The offset value can be configured by at least one of pre-defined method, RRC signaling, MAC CE signaling, DCI signaling. Optionally, the offset value can reuse the offset specified by aperiodicTriggeringOffset, or new or other parameter in signaling.
      (4) For the case that TRS and/or CSI-RS are triggered or indicated or updated or activated by DCI signaling,
if TRS or CSI-RS is aperiodic, CSI request field in DCI signaling can be used for triggering AP-TRS, or AP CSI-RS.
   Optionally, CSI request field or a new field in DCI signaling can be used for triggering AP-TRS, or AP CSI-RS and/or indicate TRS or CSI-RS resource or resource set or transmission burst.
   Optionally, CSI request field or a new field in DCI signaling can be used for triggering AP-TRS, or AP CSI-RS and/or corresponding Cell or additional PCI that is different from serving cell.
   Optionally, a triggering corresponds to the specific number of TRS or CSI-RS resource or resource set or transmission burst or time domain pattern of TRS or CSI-RS. Wherein, the specific value or time domain pattern can be configured by pre-defined or UE capability.
For periodic or semi-persistent TRS or CSI-RS, CSI request field or a new field in DCI signaling can be used for activating or enabling periodic or semi-persistent TRS or CSI-RS.
   Optionally, an activation indication or enabled indication corresponds to the specific number of TRS or CSI-RS resource or resource set or transmission burst or time domain pattern of TRS or CSI-RS. Wherein, the specific value or time domain pattern can be configured by pre-defined or UE capability.
The position to transmit the first TRS or CSI-RS can be determined based on an offset. Related content can be found in embodiment 8.
The starting of the offset can be a time in which UE starts or ends receiving or transmitting an information or signaling, or UE starts or ends receiving DCI signaling, or UE starts or ends sending HARQ-ACK information corresponding to DCI signaling that indicates TRS or CSI-RS.
The offset value can be configured by at least one of pre-defined method, RRC signaling, MAC CE signaling, DCI signaling. Optionally, the offset value can reuse the offset specified by aperiodicTriggeringOffset, or new or other parameter in signaling.

### Embodiment 7 (QCL Relationship)

Embodiment 7 describes example methods to determine QCL (quasi co-location) assumption of TRS and/or CSI-RS. Optionally, determine QCL assumption of AP-TRS and/or AP-CSI-RS.

In current specification, AP-TRS or AP-CSI-RS can be QCLed with P-TRS or P-CSI-RS. P-TRS or P-CSI-RS can be QCLed with SSB.

In some embodiment, AP-TRS or AP-CSI-RS can be QCLed with SSB or CSI-RS.

In some embodiment, AP-TRS or AP-CSI-RS is associated with a Cell identification or PCI or TCI state. Optionally, Cell can be at least one of serving cell and candidate cell. PCI can be physical cell identification of serving cell or a physical cell identification of candidate cell that is different from serving cell.

In some embodiment, AP-TRS or AP-CSI-RS is configured in the indicated or updated or activated Cell.

In some embodiment, SSB or CSI-RS is associated with serving cell or configured from serving cell.

In some embodiment, AP-TRS or AP-CSI-RS for candidate cell can be QCLed with SSB or CSI-RS included in TCI state indicated by serving cell and/or candidate cell.

In some embodiment, AP-TRS or AP-CSI-RS for candidate cell can be QCLed with DM-RS of PDSCH and DM-RS of PDCCH (physical downlink control channel). Wherein, PDSCH carries MAC CE signaling to indicate or update or activate or deactivate at least one of TCI state, Cell ID, TRS or CSI-RS.

In some embodiment, Cell identification is associated with one or more TCI state, or, corresponds to one or more TCI state.

### Embodiment 8 (TRS/CSI-RS Time-Domain Behavior)

Embodiment 8 describes example methods to provide time domain behavior of TRS or CSI-RS transmission.

In some embodiment, reference position can be a starting position or ending position in which UE receives a signaling. Optionally, signaling can be DCI signaling, or MAC CE signaling, or switch command. Optionally, signaling may indicate at least one of TCI state, target cell, timing advance (TA), offset for transmitting or receiving TRS or CSI-RS or transmitting reporting, gap for between TRS/CSI-RS transmission occasion or burst or between a TRS/CSI-RS transmission occasion or burst and reporting.

In some embodiment, reference position can be a starting position or ending position in which UE sends a HARQ-ACK information. Optionally, the HARQ-ACK information corresponds to a signaling or a transmission.

In some embodiment, TRS or CSI-RS transmission occasion or transmission burst is determined based on an offset.

In some embodiment, TRS or CSI-RS transmission occasion or transmission burst consists of X1 slot or symbol or subframe or frame. Each one or Y1 slot or symbol or subframe or frame includes Z1 TRS or CSI-RS resource or resource set. Between TRS or CSI-RS resources or resource sets have an interval of time domain. Optionally, X1, Y1, Z1 is an integer larger than or equal to 1.

In some embodiment, the offset is started from the reference position. The offset can be determined or indicated by a signaling, or pre-defined. Optionally, signaling can be DCI signaling, or MAC CE signaling, or switch command.

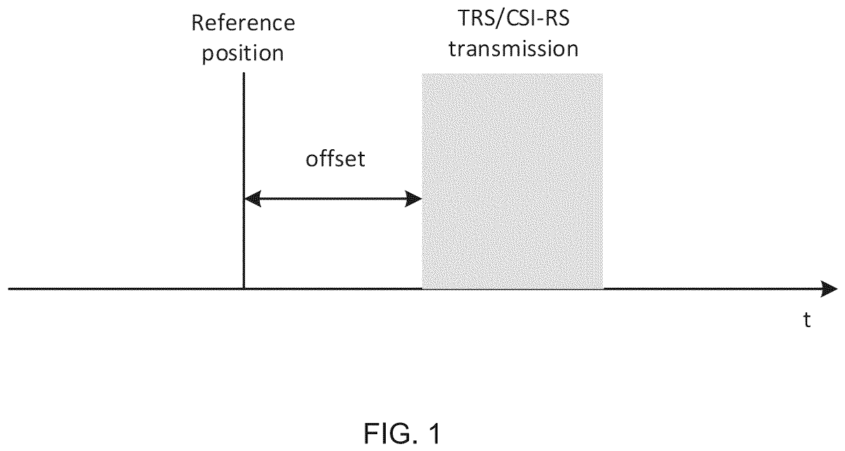

In an example, as shown in FIG. 1, TRS or CSI-RS transmission occasion or transmission burst can be started based on an offset, relative to reference position.

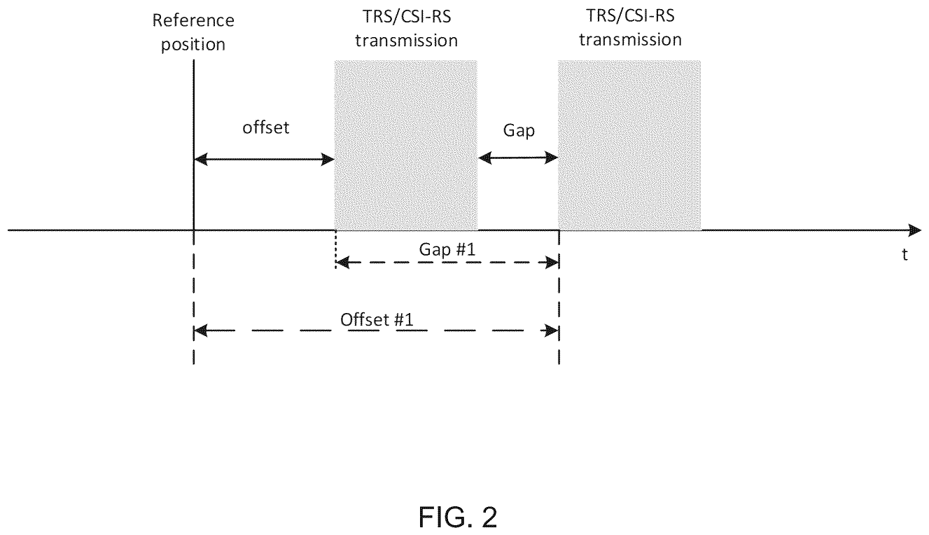

In some embodiment, if two or more TRS or CSI-RS transmission occasion or transmission burst is configured or triggered, then TRS or CSI-RS transmission occasion or transmission burst can be determined by one of the following: the first TRS or CSI-RS transmission occasion or transmission burst can be started based on an offset, relative to reference position; the second TRS or CSI-RS transmission occasion or transmission burst can be determined based on: method-1: a gap from the ending of first TRS or CSI-RS transmission occasion or transmission burst to starting of second TRS or CSI-RS transmission occasion or transmission burst; or method-2: a gap#1 from the starting of first TRS or CSI-RS transmission occasion or transmission burst to starting of second TRS or CSI-RS transmission occasion or transmission burst; or method-3: an offset #1, relative to reference position, as shown in FIG. 2. Same logic is applied for the subsequent TRS or CSI-RS transmission occasion or transmission burst.

In some embodiment, at least one of offset, offset #1, gap, gap#1 can be determined by at least one of DCI signaling, MAC CE signaling, RRC signaling, or pre-defined, or UE capability.

In some embodiment, TRS or CSI-RS transmission occasion or transmission burst and the related reporting can be determined by at least one of the following:

Any method above to be used to determined one or more TRS or CSI-RS transmission occasion or transmission burst can be applied in this case;

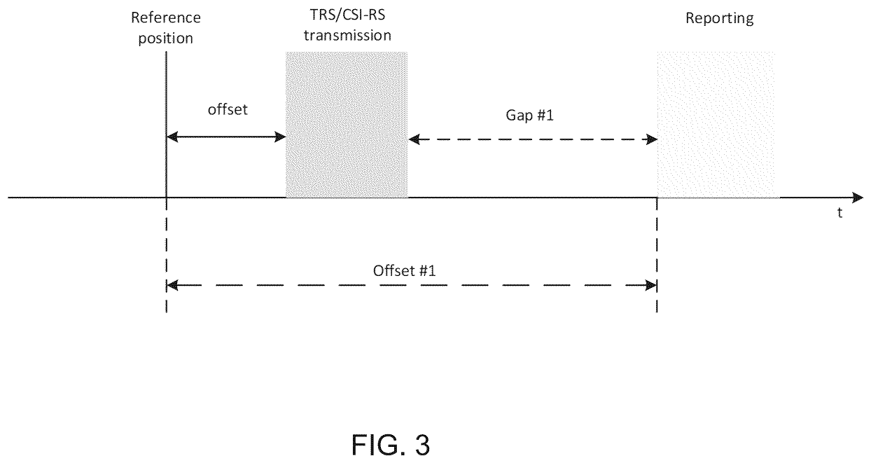

The reporting can be transmitted in a certain position as shown in FIG. 3. Optionally, the certain position can be determined based on gap #1, relative to the starting of ending of a specific TRS or CSI-RS transmission occasion or transmission burst; or based on an offset #1, relative to reference position. Optionally, the specific TRS or CSI-RS transmission occasion or transmission burst can be the first TRS or CSI-RS transmission occasion or transmission burst, or last TRS or CSI-RS transmission occasion or transmission burst, or an indicated or default TRS or CSI-RS transmission occasion or transmission burst before reporting. Optionally, at least one of gap #1, offset #1 can be determined by at least one of DCI signaling, MAC CE signaling, RRC signaling, or pre-defined, or UE capability. Optionally, an indicated or default TRS or CSI-RS transmission occasion or transmission can be determined by at least one of DCI signaling, MAC CE signaling, RRC signaling, or pre-defined, or UE capability.

In some embodiment, TRS or CSI-RS transmission occasion or transmission burst and the related reporting can be done after cell switch command, or before cell switch command or a signaling for triggering mobility, or based on a triggering command or based on an indication.

### Example Systems and Apparatus

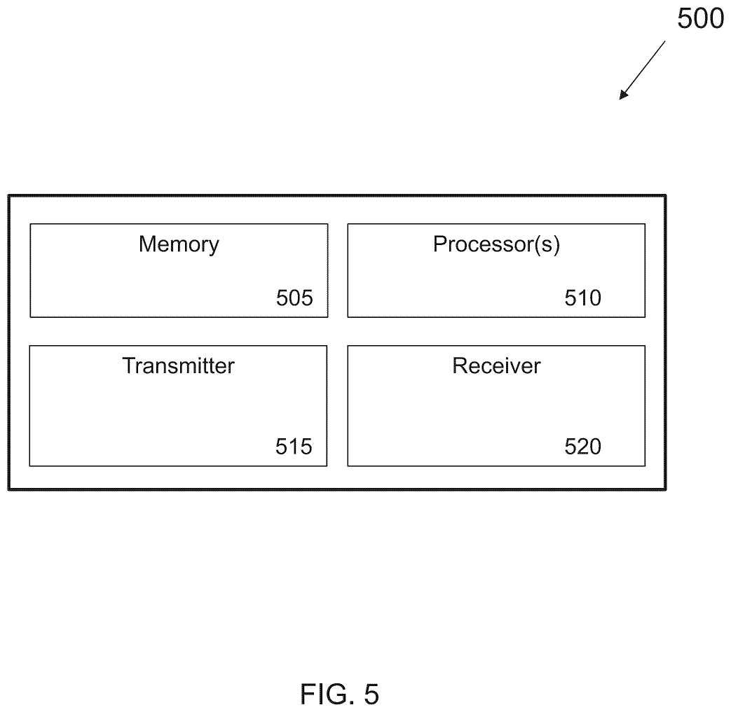

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in the various flowcharts, and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device. The hardware platform 500 may be used to implement a wireless device or a network device described in the present document.

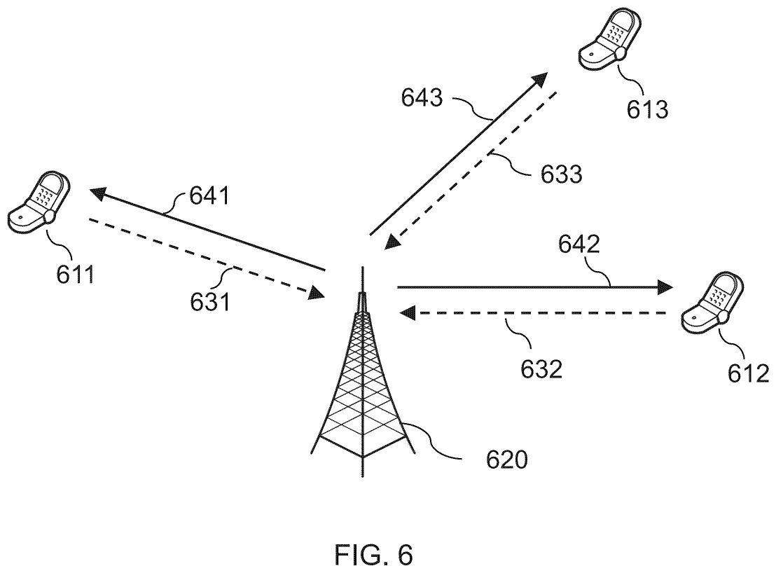

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IOT) device, and so on.

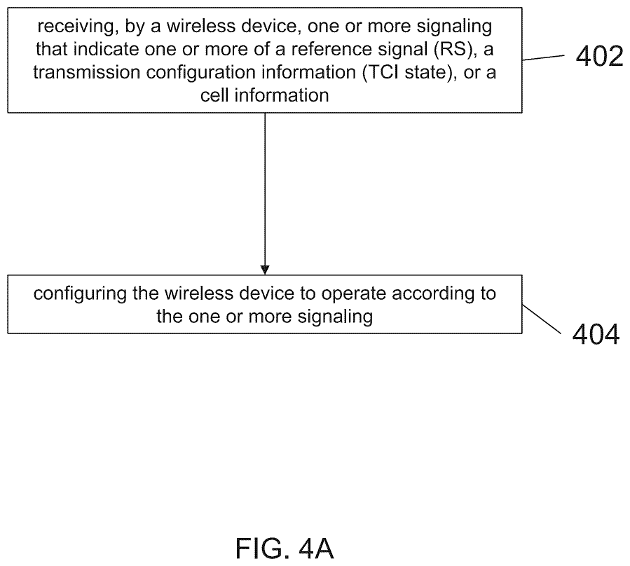

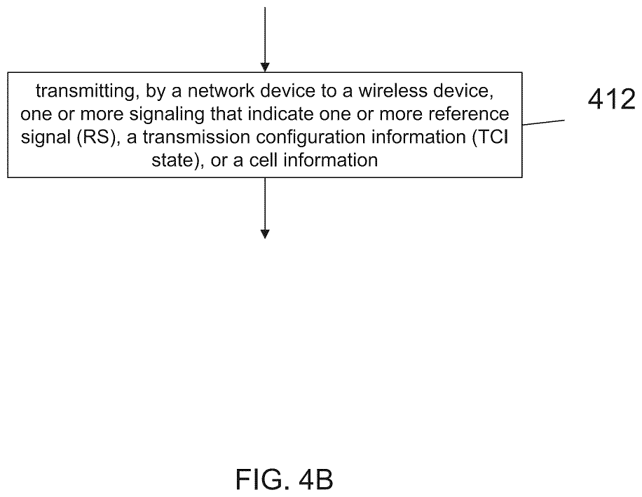

The following technical solutions may be adopted by some preferred embodiments.
1. A method of wireless communication (e.g., method depicted in FIG. 4A), comprising: receiving (402), by a wireless device, one or more signaling that indicate one or more of a reference signal (RS), a transmission configuration information (TCI state), or a cell information; and configuring (404) the wireless device to operate according to the one or more signaling.
2. A method of wireless communication (e.g., method depicted in FIG. 4B), comprising: transmitting (412), by a network device to a wireless device, one or more signaling that indicate one or more reference signal (RS), a transmission configuration information (TCI state), or a cell information. The one or more signaling may cause the wireless device to configure as described with respect to the method of FIG. 4A.
3. The method of solution 1 or 2, wherein the reference signal, the TCI state and the cell information are related using at least one of:

the RS is associated with the TCI state;

the RS is associated with the cell;

the TCI state is associated with the cell;

the TCI state is associated with the RS;

the cell is associated with the RS;

the cell is associated with the TCI state.
4. The method of solution 1 or 2, wherein, the one or more signaling includes a signaling indicating whether the RS is transmitted or triggered, and the signaling further includes one or more of: a field for the TCI; or a field for the cell information.
5. The method of solution 1 or 2, wherein the one or more signaling includes a signaling indicating the TCI state, and the signaling further includes one or more of: a field that triggers or indicates whether one or more RS can be transmitted; a field that triggers or indicates whether one or more RS can be transmitted and one or more RS transmission positions; or a field that identifies the cell information.
6. The method of solution 1 or 2, wherein the one or more signaling includes a signaling includes one or more of: a field that triggers or indicates whether one or more RS can be transmitted; a field that triggers or indicates whether one or more RS can be transmitted and RS transmission position; a field that indicates the TCI; or a field that identifies the cell information.
7. The method of solution 1 or 2, wherein the one or more signaling includes a signaling that includes a field that indicates whether the RS is transmitted or triggered, and wherein the field further indicates one or more of the TCI state or the cell information.
8. The method of solution 1 or 2, wherein the one or more signaling includes a signaling that includes a field that indicates the TCI state, and wherein the field further indicates one or more of whether the RS is allowed to be transmitted or triggered or the cell information.
9. The method of any of solutions 1-8, wherein, the signaling includes a field that represents one or more of:

does not indicate triggering or transmitting the RS;

does not indicate the TCI state;

does not indicate the cell information;

indicates the triggering or transmitting the RS;

indicates the TCI state;

indicates the cell identification;

does not indicate the triggering or transmitting the RS and indicates the TCI state;

indicates the triggering and/or transmitting the RS and does not indicate the TCI state;

indicates the triggering or transmitting the RS and the TCI state;

does not indicate the triggering or transmitting the RS and does not indicate

the cell information;

indicates the triggering or transmitting the RS and does not indicate the cell information;

indicates the triggering or transmitting the RS and indicates the cell information;

does not indicate TCI state and indicating a cell;

indicates the TCI state and does not indicate the cell information;

indicates the TCI state and indicates the cell information;

does not indicate the triggering or transmitting the RS and does not indicate the TCI state and no indicating a cell; does not indicate the triggering or transmitting the RS and does not indicate

the TCI state and indicates the cell information;

does not indicate the triggering or transmitting the RS and indicates the TCI state and does not indicate the cell identifier;

does not indicate triggering or transmitting RS and indicating TCI state and indicating a cell;

indicates the triggering or transmitting the RS and does not indicate TCI state and does not indicate the cell information;

indicates the triggering or transmitting the RS and does not indicate TCI state and indicates the cell information;

indicates the triggering or transmitting the RS and indicates the TCI state and does not indicate the cell information;

indicates the triggering or transmitting the RS and indicates the TCI state and indicates the cell information;

indicates the triggering or transmitting the RS and indicates a pattern of RS transmission or resource or resource set or transmission burst;

indicates the triggering or transmitting the RS and indicates a pattern of RS transmission or resource or resource set or transmission burst and does not indicate the TCI state;

indicates the triggering or transmitting the RS and a pattern of RS transmission or resource or resource set or transmission burst and indicating TCI state;

indicates the triggering or transmitting RS and indicates a pattern of RS transmission or resource or resource set or transmission burst and does not indicate the cell information;

indicates the triggering or transmitting RS and indicates a pattern of RS transmission or resource or resource set or transmission burst and indicating the cell information.
10. The method of solution 1 or 2, wherein the one or more are organized as follows:

a first signaling that indicates whether to trigger or transmit the RS

transmissions;

a second signaling that indicates the TCI state; and

a third signaling that signals the cell information.
11. The method of any of solutions 1 to 10, wherein, positions of RS transmissions are determined based on at least one of:

a first RS transmission position is determined based on an offset indicated in the one or more signaling relative to a first reference position; or

in case that at least two RS transmission are signaled, a subsequent RS transmission position is determined based on a gap, relative to a second reference position or a first reference position signaled in the one or more signaling.
12. The method of solution 11, wherein the first reference position comprises: a starting position at which the wireless device receives a signaling;

an ending position of a signaling for reception by the wireless device;

a starting position at which the wireless device is to commence transmission of a hybrid automatic request acknowledgement (HARQ-ACK) information corresponding to a receiving signaling; or

an ending position at which the wireless device is to end the transmission of the HARQ-ACK information corresponding to the signaling.
13. The method of solution 11, wherein the second reference position can be at least one of:

the ending time of a previous RS transmission; or

a starting time of the previous RS transmission;
14. The method of solution 12, wherein the signaling further indicates the

indicating or triggering RS transmission, or, the TCI state information that is associated with the indicated or triggered RS transmission, or, the cell information that is associated with the indicated or triggered RS transmission.
15. The method of any of solution 11 to 14, wherein the reporting position is determined based on a second offset relative to a third reference position.
16. The method of solution 15, wherein the third reference position comprises:

an ending position of a specific RS transmission;

a starting position of the specific RS transmission;

a starting position on which the wireless device receives a predefined signaling;

an ending position in which the wireless device receives the predefined signaling;

a starting position in which the wireless device is to be sent a hybrid automatic request acknowledgement (HARQ-ACK) information corresponding to the predefined signaling; or

an ending position in which the wireless device is to end sending the HARQ-ACK information corresponding to the specific signaling.
17. The method of solution 16, wherein the specific RS transmission comprises:

a first RS transmission occasion or a transmission burst before the reporting;

a last RS transmission occasion or a transmission burst before the reporting;

an indicated or default RS transmission occasion or a transmission burst before the reporting.
18. The method of any of solutions 1 to 17, wherein RS comprises a tracking reference signal (TRS) or a channel state information reference signal (CSI-RS), or a synchronization signal physical broadcast channel (SS/PBCH) block.
19. The method of any of solutions 1 to 17, wherein the one or more signaling comprise a downlink control information (DCI) signaling or a medium access control (MAC) signaling.
20. The method of any of solutions 1 to 19, at least one of the relationship among the RS, the TCI, the cell information, a maximum number of indicated or activated or updated TCI state, a maximum number of transmitted or measured or reported RS resources or resource sets or a transmission burst, a maximum number of cells, a gap, an offset, second offset, a minimum time for application of a TCI state are determined from: a downlink control information signaling, a medium access control control element signaling, a radio resource control signaling, or is pre-defined, or depends on a capability of the wireless device.
21. The method of solution 18 to 20, wherein, the TRS, the CSI-RS or the SSB is quasi-co-located (QCLed) with at least one of a demodulation reference signal (DM-RS) of a physical downlink shared channel PDSCH, a DM-RS of a physical downlink control channel PDCCH, another SSB, another CSI-RS, a sounding reference signal SRS or a preamble for candidate cell.
22. The method of any of solutions 1 to 21, wherein:

a first signaling is received in a downlink control indicator (DCI) and wherein a second signaling is received in a MAC control element (MAC CE), or

the second signaling is received in a downlink control indicator (DCI) and wherein the first signaling is received in a MAC control element (MAC CE), or

the first signaling is received in a first DCI and the second signaling is received in a second DCI, or

the first signaling is received in a first MAC CE and the second signaling is received in a second MAC CE.
23. A wireless communication apparatus comprising a processor configured to implement method of any of solutions 1-22.
24. A computer readable medium having code stored thereon, the code, upon execution, causing a processor to implement a method described in any of solutions 1-22.

It will be appreciated that the present document discloses various techniques that are used by embodiments to reduce L1/L2 mobility delays.

In one example aspect, new signaling format and timing are disclosed which allow indication of Cell ID(s)/TCI state and/or TRS/CSI-RS. According to various embodiments: (a) the first signaling may indicate Cell ID(s)/TCI state and the second signaling may indicate TRS/CSI-RS. Here, one MAC-CE may indicate Cell ID(s)/TCI state and another MAC-CE may indicate TRS/CSI-RS. Alternatively, one DCI may indicate Cell ID(s)/TCI state and another DCI may indicate TRS/CSI-RS. Alternatively, one MAC-CE may indicate Cell ID(s)/TCI state and one DCI may indicate TRS/CSI-RS. Alternatively, one DCI may indicate Cell ID(s)/TCI state and one MAC-CE may indicate TRS/CSI-RS

It will also be appreciated that the present document discloses using a combined signaling that may indicate Cell ID(s)/TCI state and TRS/CSI-RS. Here, a combined MAC-CE may indicate Cell ID(s)/TCI state and TRS/CSI-RS. Alternatively, a combined DCI may indicate Cell ID(s)/TCI state and TRS/CSI-RS. In the above described embodiments, a field can jointly indicate TCI Cell ID(s)/TCI state and TRS/CSI-RS; or separate field to indicate Cell ID(s)/TCI state and TRS/CSI-RS, respectively.

It will further be appreciated that various examples and rules for timelines of transmission of AP-TRS and CSI-RS are disclosed. It will further be appreciated that rules and techniques for QCL assumption of AP-TRS and CSR-RS are disclosed.

It will further be appreciated that, although various implementation options are described with preface “option” or “alternatives” under various sections, the disclosed techniques may also be used with another embodiment that does not specifically list this option or alternative for brevity of the text.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
receiving, by a wireless device, one or more signaling that indicate one or more of a reference signal (RS), a transmission configuration information (TCI state), or a cell information; and
configuring the wireless device to operate according to the one or more signaling.

2. (canceled)

3. The method of claim 1, wherein the reference signal, the TCI state and the cell information are related using at least one of:
the RS is associated with the TCI state;
the RS is associated with the cell;
the TCI state is associated with the cell;
the TCI state is associated with the RS;
the cell is associated with the RS;
the cell is associated with the TCI state.

4. The method of claim 1, wherein, the one or more signaling includes a signaling indicating whether the RS is transmitted or triggered, and the signaling further includes one or more of:
a field for the TCI; or
a field for the cell information.

5. The method of claim 1, wherein the one or more signaling includes a signaling indicating the TCI state, and the signaling further includes one or more of:
a field that triggers or indicates whether one or more RS can be transmitted;
a field that triggers or indicates whether one or more RS can be transmitted and one or more RS transmission positions; or
a field that identifies the cell information.

6. The method of claim 1, wherein the one or more signaling includes a signaling includes one or more of:
a field that triggers or indicates whether one or more RS can be transmitted;
a field that triggers or indicates whether one or more RS can be transmitted and RS transmission position;
a field that indicates the TCI; or
a field that identifies the cell information.

7. The method of claim 1, wherein the one or more signaling includes a signaling that includes a field that indicates whether the RS is transmitted or triggered, and wherein the field further indicates one or more of the TCI state or the cell information.

8. The method of claim 1, wherein the one or more signaling includes a signaling that includes a field that indicates the TCI state, and wherein the field further indicates one or more of whether the RS is allowed to be transmitted or triggered or the cell information.

9. The method of claim 1, wherein, the signaling includes a field that represents one or more of:
does not indicate triggering or transmitting the RS;
does not indicate the TCI state;
does not indicate the cell information;
indicates the triggering or transmitting the RS;
indicates the TCI state;
indicates [[the]] a cell identification;
does not indicate the triggering or transmitting the RS and indicates the TCI state;
indicates the triggering and/or transmitting the RS and does not indicate the TCI state;
indicates the triggering or transmitting the RS and the TCI state;
does not indicate the triggering or transmitting the RS and does not indicate the cell information;
indicates the triggering or transmitting the RS and does not indicate the cell information;
indicates the triggering or transmitting the RS and indicates the cell information;
does not indicate TCI state and indicating a cell;
indicates the TCI state and does not indicate the cell information;
indicates the TCI state and indicates the cell information;
does not indicate the triggering or transmitting the RS and does not indicate the TCI state and no indicating a cell;
does not indicate the triggering or transmitting the RS and does not indicate the TCI state and indicates the cell information;
does not indicate the triggering or transmitting the RS and indicates the TCI state and does not indicate the cell identification;
does not indicate triggering or transmitting RS and indicating TCI state and indicating a cell;
indicates the triggering or transmitting the RS and does not indicate TCI state and does not indicate the cell information;
indicates the triggering or transmitting the RS and does not indicate TCI state and indicates the cell information;
indicates the triggering or transmitting the RS and indicates the TCI state and does not indicate the cell information;
indicates the triggering or transmitting the RS and indicates the TCI state and indicates the cell information;
indicates the triggering or transmitting the RS and indicates a pattern of RS transmission or resource or resource set or transmission burst;
indicates the triggering or transmitting the RS and indicates a pattern of RS transmission or resource or resource set or transmission burst and does not indicate the TCI state;
indicates the triggering or transmitting the RS and a pattern of RS transmission or resource or resource set or transmission burst and indicating TCI state;
indicates the triggering or transmitting RS and indicates a pattern of RS transmission or resource or resource set or transmission burst and does not indicate the cell information;
indicates the triggering or transmitting RS and indicates a pattern of RS transmission or resource or resource set or transmission burst and indicating the cell information.

10. The method of claim 1, wherein the one or more are organized as follows:
a first signaling that indicates whether to trigger or transmit the RS transmissions;
a second signaling that indicates the TCI state; and
a third signaling that signals the cell information.

11. The method of claim 1, wherein, positions of RS transmissions are determined based on at least one of:
a first RS transmission position is determined based on an offset indicated in the one or more signaling relative to a first reference position; or
in case that at least two RS transmission are signaled, a subsequent RS transmission position is determined based on a gap, relative to a second reference position or a first reference position signaled in the one or more signaling.

12. The method of claim 11, wherein the first reference position comprises:
a starting position at which the wireless device receives a signaling;
an ending position of a signaling for reception by the wireless device;
a starting position at which the wireless device is to commence transmission of a hybrid automatic request acknowledgement (HARQ-ACK) information corresponding to a receiving signaling; or
an ending position at which the wireless device is to end the transmission of the HARQ-ACK information corresponding to the signaling.

13. The method of claim 11, wherein the second reference position can be at least one of:
an ending time of a previous RS transmission; or
a starting time of the previous RS transmission;

14. (canceled)

15. The method of claim 11, wherein a reporting position is determined based on a second offset relative to a third reference position.

16. The method of claim 15, wherein the third reference position comprises:
an ending position of a specific RS transmission;
a starting position of the specific RS transmission;
a starting position on which the wireless device receives a predefined signaling;
an ending position in which the wireless device receives the predefined signaling;
a starting position in which the wireless device is to be sent a hybrid automatic request acknowledgement (HARQ-ACK) information corresponding to the predefined signaling; or
an ending position in which the wireless device is to end sending the HARQ-ACK information corresponding to the specific signaling.

17. The method of claim 16, wherein the specific RS transmission comprises:
a first RS transmission occasion or a transmission burst before the reporting;
a last RS transmission occasion or a transmission burst before the reporting;
an indicated or default RS transmission occasion or a transmission burst before the reporting.

18. The method of claim 1, wherein RS comprises a tracking reference signal (TRS) or a channel state information reference signal (CSI-RS), or a synchronization signal physical broadcast channel (SS/PBCH) block.

19. The method of claim 1, wherein the one or more signaling comprise a downlink control information (DCI) signaling or a medium access control (MAC) signaling.

20. The method of claim 1, wherein at least one of relationships among the RS, the TCI, the cell information, a maximum number of indicated or activated or updated TCI state, a maximum number of transmitted or measured or reported RS resources or resource sets or a transmission burst, a maximum number of cells, a gap, an offset, second offset, a minimum time for application of a TCI state are determined from: a downlink control information signaling, a medium access control control element signaling, a radio resource control signaling, or is pre-defined, or depends on a capability of the wireless device.

21. The method of claim 18, wherein, the TRS, the CSI-RS or an SSB is quasi-co-located (QCLed) with at least one of a demodulation reference signal (DM-RS) of a physical downlink shared channel PDSCH, a DM-RS of a physical downlink control channel PDCCH, another SSB, another CSI-RS, a sounding reference signal SRS or a preamble for candidate cell.

22. The method of claim 1, wherein:
a first signaling is received in a downlink control indicator (DCI) and wherein a second signaling is received in a MAC control element (MAC CE), or
the second signaling is received in a downlink control indicator (DCI) and wherein the first signaling is received in a MAC control element (MAC CE), or
the first signaling is received in a first DCI and the second signaling is received in a second DCI, or
the first signaling is received in a first MAC CE and the second signaling is received in a second MAC CE.

23. (canceled)

24. (canceled)
